(19) United States
(12) Patent Application Publication
(10) Pub. No.: US 2014/0065912 A1
(43) Pub. Date: Mar. 6, 2014

(54) METHOD OF PREPARING A CARBON-CARBON COMPOSITE FIBER AND A CARBON HEATER MANUFACTURED USING THE SAME

(71) Applicants: Youngjun LEE, Seoul (KR); Seongho Cho, Seoul (KR)

(72) Inventors: Youngjun LEE, Seoul (KR); Seongho Cho, Seoul (KR)

(21) Appl. No.: 13/901,820

(22) Filed: May 24, 2013

(30) Foreign Application Priority Data
Sep. 5, 2012 (KR) 10-2012-0098071

(51) Int. Cl. C09D 5/26; B32B 5/02

(52) U.S. Cl. CPC C09D 5/26; B32B 5/024
USPC 442/287; 427/299; 427/228; 442/290

(57) ABSTRACT

A method of preparing a carbon-carbon composite fiber and a carbon heater manufactured using the same are provided. The method may include providing a support, weaving a carbon fiber onto the support, forming a mixed solution containing a carbon precursor and an organic solvent, and immersing the carbon fiber into the mixed solution. The support may include a polymer having a melting point of about 250° C. or less, or a polymer having a functional group which does not react with a hydroxyl group (—OH).

### CROSS-REFERENCE TO RELATED APPLICATION(S)

The present application claims priority to Korean Patent Application No. 10-2012-0098071 filed in Korea on Sep. 5, 2012, which is hereby incorporated by reference in its entirety.

### BACKGROUND

1. Field

A method of preparing a carbon-carbon composite fiber and a carbon heater manufactured using the same are disclosed herein.

2. Background

Methods of preparing a carbon-carbon composite fiber and a carbon heater manufactured using the same are known. However, they suffer from various disadvantages.

### BRIEF DESCRIPTION OF THE DRAWINGS

Embodiments will be described in detail with reference to the following drawings in which like reference numerals refer to like elements, wherein:

FIG. 1 is a flowchart illustrating a method of preparing carbon-carbon composite fibers according to an embodiment; and

FIGS. 2 and 3 are graphs illustrating results obtained through an infrared spectrometer (IR) in a case in which a Teflon rod and a quartz rod are respectively used as supports when carbon-carbon composite fibers are prepared according to an embodiment.

### DETAILED DESCRIPTION

In the description of embodiments hereinbelow, it should be understood that when each substrate, layer, film, or electrode is referred to as being ‘on’ or ‘under’ another substrate, layer, film, or electrode, the terminology of ‘on’ and ‘under’ includes both the meanings of ‘directly’ and ‘indirectly’. Further, the reference about ‘on’ and ‘under’ each component layer will be made on the basis of drawings. In addition, the sizes of elements and the relative sizes between elements may be exaggerated for further understanding of the present disclosure.

Carbon fibers (CFs) are carbon fiber materials having a carbon content of about 90% or more. CFs have flexibility, high strength, high elasticity, and adsorbability in addition to natural properties of a carbon material, such as heat resistance, chemical stability, electrical conductivity, thermal conductivity, mechanical strength, and biocompatibility. Thus, CFs may be utilized in various shapes in cutting edge materials or general-purpose materials.

In particular, CFs may have high thermal conductivity, low thermal expansion coefficient, and high heat shock resistance. There have been many attempts to utilize CFs in ultra high temperature structures, to which a high temperature is applied for a moment, such as heating wires, heaters, friction materials for airplanes, heat-resistant materials for nuclear reactors, and rocket nozzles, for example, in recent years using the above-described properties.

As CFs have high thermal conductivity, thermal expansion coefficient, and heat shock resistance, the CFs may be widely used as heaters. Also, as CFs have low electrical conductivity, the CFs may effectively generate heat at a low power. However, CFs may have low structural stability, and it may be difficult to adjust the CFs to a target output. Thus, to solve the above-described limitations, a carbon layer may be applied on the CFs using a vapor or liquid deposition method.

However, in the case of the vapor deposition method, processes may be inefficient, and noxious gases may be generated. In the case of the liquid deposition method, when the CFs are immersed into a liquid solution, a support for controlling shapes of the CFs may be inserted. As a result, the support may be bonded to the CFs during the thermal process. Thus, costs for removing the support may be added.

Thus, when carbon-carbon composite fibers are prepared through the liquid deposition method, a preparation method in which the bonding of the support and the CFs is prevented may be required.

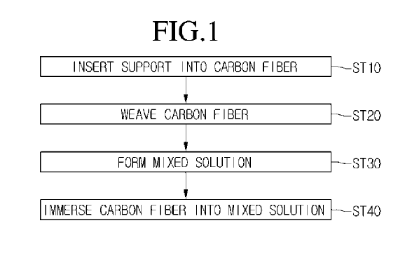

Hereinafter, a method of preparing carbon-carbon composite fibers according to an embodiment will be described with reference to FIG. 1. Referring to FIG. 1, a method of preparing carbon-carbon composite fibers according to an embodiment may include providing a support, in step ST10; weaving a carbon fiber onto the support, in step ST20; forming a mixed solution containing a carbon precursor and an organic solvent, in step ST30; and immersing the carbon fiber into the mixed solution, in step ST40.

In the providing of the support, in step ST10, a support having a specific shape may be provided according to a desired shape to realize a specific shape when the carbon fiber is woven. For example, to weave a circular carbon fiber, a round bar or a support having a tube shape may be provided. The carbon fiber may be woven onto the support. That is, the support may realize a desired shape of the carbon fiber when the carbon fiber is woven.

The support may include a material that prevents the carbon fiber from being damaged and/or has thermal durability. For example, the support may include various polymers. In more detail, the support may include a polymer having a melting point of about 250° C. or less, or a polymer having a functional group which does not react with a hydroxyl group (—OH). The polymer having a melting point of about 250° C. or less may include polypropylene or polyethylene terephthalate. The polymer which does not react with the hydroxyl group (—OH) may include Teflon.

In the weaving of the carbon fiber, in step ST20, the carbon fiber may be woven in a desired shape onto the support. The carbon fiber may be woven by a well-known weaving method. Also, the carbon fiber may be woven in various shapes according to a shape of the support.

For example, when a support having a round bar or tube shape is used, the carbon fiber may be woven in a circular mesh shape. However, embodiments are not limited thereto. For example, supports having various shapes may be inserted to weave carbon fibers having various shapes through the weaving process according to the shapes of the supports.

In the forming of the mixed solution of the carbon precursor and the organic solvent, in step ST30, a mixed solution for liquid-depositing the carbon fiber woven in the weaving process may be formed. The organic solvent may include a material selected from the group consisting of dimethylacetamide (DMAc), N,N-dimethylformamide (DMF), tetrahydrofuran (THF), dimethyl sulfoxide (DMSO), and combinations thereof. For example, the organic solvent may be tetrahydrofuran (THF).

The carbon precursor may include a material selected from the group consisting of naphtha cracking bottom oil, coal-tar pitch, oil pitch, polyacrylonitrile (PAN), phenol, and combinations thereof. The bottom oil may include pyrolized fuel oil (PFO) generated in a naphtha cracking process. As described above, residue generated in a petroleum refining process may be used as the carbon precursor to reduce production costs. The solid phase carbon precursor, such as the coal-tar pitch or the oil pitch of the carbon precursor, may be dispersed into the organic solvent. The liquid phase carbon precursor, such as pyrolized fuel oil (PFO), may be mixed with the organic solvent.

The carbon precursor mixed with the organic solvent may have a concentration of about 10 wt % to about 90 wt %. For example, a mixture ratio of the liquid carbon precursor and the organic solvent may range from about 50 wt % to about 90 wt %; however, embodiments are not limited thereto. Also, a mixture ratio of the solid carbon precursor and the organic solvent may range about 10 wt % to about 15 wt %; however, embodiments are not limited thereto.

In the immersing of the carbon fiber into the mixed solution, in step ST40, the carbon fiber woven in the weaving process may be immersed into the mixed solution. The carbon fiber may be immersed into the mixed solution for several minutes to several tens of minutes. Also, as needed, the immersing process may be repeatedly performed several times. After the immersing process is performed, the carbon fiber immersed into the mixed solution may be thermally treated. That is, the immersed carbon fiber may be thermally treated to convert the carbon precursor within the mixed solution into a carbon material. Then, the carbon material may be impregnated on the carbon fiber.

In the thermal treatment process, the immersed carbon fiber may be stabilized in an oxidative gas atmosphere at a temperature of about 50° C. to about 300° C. Then, the oxidation-stabilized carbon fiber may be carbonized at a temperature of about 800° C. to about 1,000° C., and under an inert or vacuum atmosphere, to finally impregnate the carbon material onto the carbon fiber. The carbon-carbon composite fiber prepared through the above-described processes may be used as a carbon heater. That is, a carbon heater may be manufactured using a plurality of carbon-carbon composite fibers.

In the thermal treatment process, the support inserted into the carbon fiber may be smoothly removed. In more detail, if the support includes the polymer having a melting point of about 250° C. or less, the support may be evaporated in the high-temperature thermal treatment process and thus be removed. Also, if the support includes the polymer which does not react with the hydroxyl group (—OH), as the support and the carbon fiber do not react with each other, it may prevent the support and the carbon fiber from being chemically bonded to each other. Thus, the support may be smoothly evaporated in the high-temperature thermal treatment process and then be removed.

In the method of preparing a carbon-carbon composite fiber according to embodiments, as a specific polymer is used as the support inserted into the weaving process, a separate process for removing the support after the mixed solution is deposited, that is, applied on the carbon fiber may be omitted. That is, as the support is evaporated and removed in the thermal treatment process, the support may be removed while the thermal treatment process is performed.

Also, the method according to embodiments may prevent the support and the carbon fiber from being chemically bonded to each other in the thermal treatment process. That is, as the polymer which does not react with the hydroxyl group (—OH) is used as the support, it may prevent the carbon fiber and the support from being chemically bonded to each other. Thus, the support may be easily removed to prevent the carbon fiber from being damaged by the support.

Hereinafter, an embodiment will be described in detail with reference to preparation examples and a comparison example. The preparation examples are merely examples for more clearly explaining the embodiment, and thus, the embodiment is not limited to the preparation examples.

### Preparation Example 1

After a support is provided and a weaving process performed, the woven carbon fiber is immersed into a mixed solution of a carbon precursor and an organic solvent to liquid-deposit the mixed solution on the carbon fiber and to thermally treat the carbon fiber, thereby preparing a carbon-carbon composite fiber. Then, whether the support exists and a residue amount of carbon precursor inserted in the support are checked.

In this preparation example, polypropylene is used as the support, a T700 12K carbon fiber (Toray, Japan) is used as the carbon fiber, and tetrahydrofuran (THF) is used as the organic solvent. Also, phenol is used as the carbon precursor.

### Preparation Example 2

Preparation example 2 is the same as Preparation example 1, except that polyethylene terephthalate is used as the support. That is, the carbon-carbon composite fiber is prepared, whether the support exists, and a residue amount of carbon precursor inserted in the support are checked.

### Preparation Example 3

Preparation example 3 is the same as Preparation example 1, except that Teflon is used as the support. That is, the carbon-carbon composite fiber is prepared, whether the support exists, and a residue amount of carbon precursor inserted in the support are checked.

### Comparison Example

Comparison example is the same as Preparation example 1, except that quartz is used as the support. That is, the carbon-carbon composite fiber is prepared, whether the support exists, and a residue amount of carbon precursor inserted in the support are checked.

TABLE 1

| | Support existence/ | Whether carbon precursor exists |
|---|---|---|
| | nonexistence | within support |
| Preparation | nonexistence | — |
| example 1 | | |
| Preparation | nonexistence | — |
| example 2 | | |
| Preparation | existence | nonexistence |
| example 3 | | |
| Comparison | existence | existence |
| example | | |

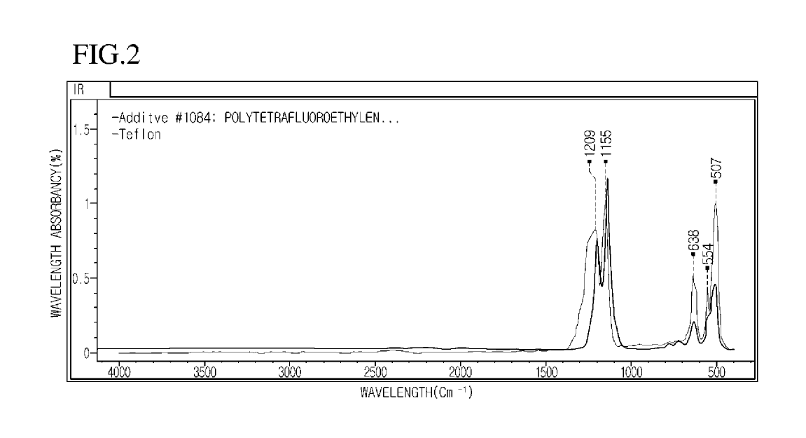

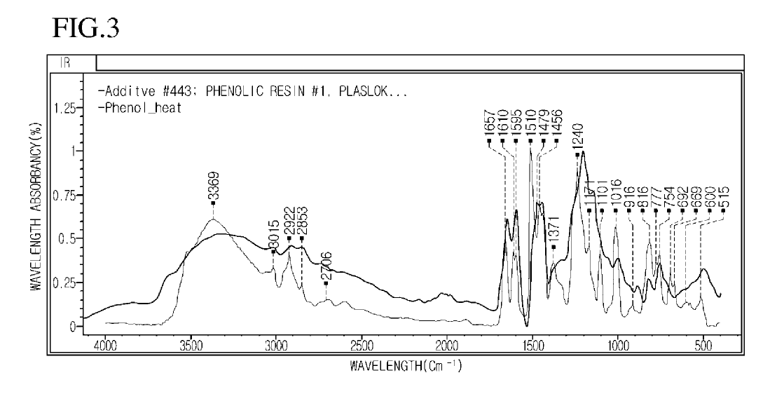

Referring to FIGS. 2 and 3 and Table 1, it can be seen that the support is completely removed while the thermal treatment process is performed in the carbon-carbon composite fiber prepared by Preparation examples 1 and 2, and the carbon precursor does not exist within the support in Preparation example 3. On the other hand, it can be seen that the carbon precursor exists within the support in the carbon-carbon composite fiber prepared by the Comparison example.

That is, in Preparation examples 1 and 2, the support and the carbon precursor are evaporated together with each other while the thermal treatment process is performed. Thus, the carbon precursor does not exist within the support.

Also, FIGS. 2 and 3 illustrate an IR graph in Preparation example 3 and the Comparison example, respectively. Referring to FIGS. 2 and 3, as shown in FIG. 2, in Preparation example 3, a peak of phenol that is the carbon precursor does not exist within the Teflon support, but only a Teflon peak exists. On the other hand, as shown in FIG. 3, in the Comparison example, it can be seen that a peak of phenol that is the carbon precursor exists within the quartz support.

That is, referring to FIGS. 2 and 3, it can be seen that the Teflon support does not chemically react with the carbon precursor, and the quartz support reacts with the carbon precursor so that the carbon precursor exists on the quartz support. That is, in the carbon-carbon composite fiber prepared by the Comparison example, the support and the carbon precursor react with each other. Thus, it is difficult to remove the support. On the other hand, in the carbon-carbon composite fiber prepared by Preparation examples 1 to 3, the support and the carbon precursor are evaporated and removed while the thermal treatment process is performed, or do not react with each other to easily remove the support.

Thus, in the method of preparing a carbon-carbon composite fiber according to embodiments, the method may be simplified to improve process efficiency. Also, as the method according to embodiments prevents the carbon-carbon composite fiber from being damaged by the reaction between the support and the carbon precursor, process yield may be improved, and process costs reduced.

In the method of preparing a carbon-carbon composite fiber according to embodiments, as a specific polymer is used as the support inserted into the weaving process, a separate process for removing the support after the mixed solution is deposited, that is, applied on the carbon fiber, may be omitted. That is, as the support is evaporated and removed in the thermal treatment process, the support may be removed while the thermal treatment process is performed.

Also, the support and the carbon fiber may be prevented from being chemically bonded to each other in the thermal treatment process. That is, as the polymer which does not react with the hydroxyl group (—OH) is used as the support, it may prevent the carbon fiber and the support from being chemically bonded to each other. Thus, the support may be easily removed to prevent the carbon fiber from being damaged by the support.

Embodiments disclosed herein provide a method of preparing a carbon-carbon composite fiber in which bonding of a support and a carbon fiber may be reduced when the carbon-carbon composite fiber is prepared, such that the support may be easily removed from the carbon fiber, and a carbon heater manufactured using the same.

Embodiments disclosed herein provide a method of preparing a carbon-carbon composite fiber that may include inserting a support into a carbon fiber; weaving the carbon fiber; forming a mixed solution containing a carbon precursor and an organic solvent; and immersing the carbon fiber into the mixed solution. The support may include a polymer having a melting point of about 250° C. or less or a polymer having a functional group which does not react with a hydroxyl group (—OH).

A particular feature, structure, or effects described in connection with embodiments may be included in at least one embodiment, and is not limited to only one embodiment. Further, when a particular feature, structure, or characteristic is described in connection with any embodiment, it is submitted that it is within the purview of one skilled in the art to effect such feature, structure, or characteristic in connection with other embodiments. Therefore, contents with respect to various variations and modifications will be construed as being included in the scope.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. Therefore, contents with respect to various variations and modifications will be construed as being included in the scope of the present disclosure.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of preparing a carbon-carbon composite fiber, the method comprising:
providing a support;
weaving a carbon fiber onto the support;
forming a mixed solution containing a carbon precursor and an organic solvent; and
immersing the carbon fiber into the mixed solution, wherein the support comprises a polymer having a melting point of about 250° C. or less, or a polymer having a functional group which does not react with a hydroxyl group (—OH).

2. The method according to claim 1, wherein the support comprises polypropylene, polyethylene terephthalate, or Teflon.

3. The method according to claim 1, wherein the support has a round bar shape or a tube shape.

4. The method according to claim 1, wherein the carbon precursor comprises at least one material selected from the group consisting of naphtha cracking bottom oil, coal-tar pitch, oil pitch, polyacrylonitrile (PAN), phenol, and combinations thereof.

5. The method according to claim 1, wherein the organic solvent comprises at least one material selected from the group consisting of dimethylacetamide (DMAc), N,N-dimethylformamide (DMF), tetrahydrofuran (THF), dimethyl sulfoxide (DMSO), and combinations thereof.

6. The method according to claim 1, wherein after the immersing of the carbon fiber into the mixed solution, the method further comprises:
thermally treating the immersed carbon fiber to convert the carbon precursor into a carbon material; and
impregnating the carbon material on the carbon fiber.

7. The method according to claim 6, wherein the thermal treatment comprises:
stabilizing the immersed carbon fiber at a temperature of about 50° C. to about 300° C.; and
carbonizing the oxidation-stabilized carbon fiber at a temperature of about 800° C. to about 1,000° C. under an inert or vacuum atmosphere.

8. The method according to claim 1, wherein the carbon precursor mixed with the organic solvent has a concentration of about 10 wt % to about 90 wt %.

9. The method according to claim 1, wherein the immersing is repeatedly performed.

10. A carbon-carbon composite fiber preparing using the method of claim 1.

11. A carbon heater comprising a plurality of carbon-carbon composite fibers prepared using the method of claim 1.

12. A method of preparing a carbon-carbon composite fiber, the method comprising:
weaving a carbon fiber onto a support; and
immersing the carbon fiber into a mixed solution containing a carbon precursor and an organic solvent, wherein the support comprises a polymer having a melting point of about 250° C. or less.

13. The method according to claim 12, wherein the support comprises polypropylene, polyethylene terephthalate, or Teflon.

14. The method according to claim 12, wherein the carbon precursor comprises at least one material selected from the group consisting of naphtha cracking bottom oil, coal-tar pitch, oil pitch, polyacrylonitrile (PAN), phenol, and combinations thereof.

15. The method according to claim 12, wherein the organic solvent comprises at least one material selected from the group consisting of dimethylacetamide (DMAc), N,N-dimethylformamide (DMF), tetrahydrofuran (THF), dimethyl sulfoxide (DMSO), and combinations thereof.

16. The method according to claim 12, wherein after the immersing of the carbon fiber into the mixed solution, the method further comprises:
thermally treating the immersed carbon fiber to convert the carbon precursor into a carbon material; and
impregnating the carbon material on the carbon fiber.

17. The method according to claim 16, wherein the thermal treatment comprises:
stabilizing the immersed carbon fiber at a temperature of about 50° C. to about 300° C.; and
carbonizing the oxidation-stabilized carbon fiber at a temperature of about 800° C. to about 1,000° C. under an inert or vacuum atmosphere.

18. A carbon-carbon composite fiber preparing using the method of claim 12.

19. A carbon heater comprising a plurality of carbon-carbon composite fibers prepared using the method of claim 12.

20. A method of preparing a carbon-carbon composite fiber, the method comprising:
weaving a carbon fiber on a support; and
immersing the carbon fiber into a mixed solution containing a carbon precursor and an organic solvent, wherein the support comprises a polymer having a functional group which does not react with a hydroxyl group (—OH).

21. The method according to claim 20, wherein the support comprises polypropylene, polyethylene terephthalate, or Teflon.

22. The method according to claim 20, wherein the carbon precursor comprises at least one material selected from the group consisting of naphtha cracking bottom oil, coal-tar pitch, oil pitch, polyacrylonitrile (PAN), phenol, and combinations thereof.

23. The method according to claim 20, wherein the organic solvent comprises at least one material selected from the group consisting of dimethylacetamide (DMAc), N,N-dimethylformamide (DMF), tetrahydrofuran (THF), dimethyl sulfoxide (DMSO), and combinations thereof.

24. The method according to claim 20, wherein after the immersing of the carbon fiber into the mixed solution, the method further comprises:
thermally treating the immersed carbon fiber to convert the carbon precursor into a carbon material; and
impregnating the carbon material on the carbon fiber.

25. The method according to claim 24, wherein the thermal treatment comprises:
stabilizing the immersed carbon fiber at a temperature of about 50° C. to about 300° C.; and
carbonizing the oxidation-stabilized carbon fiber at a temperature of about 800° C. to about 1,000° C. under an inert or vacuum atmosphere.

26. A carbon-carbon composite fiber preparing using the method of claim 20.

27. A carbon heater comprising a plurality of carbon-carbon composite fibers prepared using the method of claim 20.
